(19) United States
(12) Patent Application Publication
(10) Pub. No.: US 2026/0261139 A1
(43) Pub. Date: Sep. 3, 2026

(54) RENEWABLE ENERGY ELECTRIC POWER GENERATION SYSTEM AND METHOD FOR CHARGING ELECTRIC POWER STORAGE DEVICE

(71) Applicant: ENERGYWITH CO., LTD., Chiyoda-ku, Tokyo (JP)

(72) Inventors: Junya ITO, Chiyoda-ku, Tokyo (JP); Hiroshi ARITA, Chiyoda-ku, Tokyo (JP)

(73) Assignee: ENERGYWITH CO., LTD., Chiyoda-ku, Tokyo (JP)

(21) Appl. No.: 18/871,598

(22) PCT Filed: May 26, 2023
(86) PCT No.: PCT/JP2023/019807

§ 371 Date: Dec. 4, 2024

(30) Foreign Application Priority Data
Jun. 6, 2022 (JP) 2022-091548

(51) Int. Cl. H02J 7/82; H01M 10/06; H01M 10/42; H01M 10/44; H02J 3/32; H02J 3/38; H02J 7/04; H02J 7/52; H02J 101/24; H02J 101/28

(52) U.S. Cl. CPC H02J 7/82; H01M 10/06; H01M 10/425; H01M 10/441; H02J 3/32; H02J 3/38; H02J 7/04; H02J 7/52; H02J 2101/24; H02J 2101/28

(57) ABSTRACT

A renewable energy power generation system includes a renewable energy power generation device that generates power with renewable natural energy, a power storage device capable of storing power output from the renewable energy power generation device and power supplied from an external system, and capable of releasing the power stored, and a control section that controls charge of the power storage device so that a state of charge (SOC) of the power storage device is equal to or more than a lower limit value of a state of charge (SOC) of the power storage device, which is determined based on power generation output-related information of the renewable energy power generation device.

### TECHNICAL FIELD

The present disclosure relates to a renewable energy power generation system and a method of charging a power storage device.

### BACKGROUND ART

In power storage systems with storage batteries such as lead storage batteries, equalizing charge for allowing such storage batteries to be in the fully charged state is periodically carried out from the viewpoint of inhibiting such storage batteries from being degraded.

For example, Patent Literature 1 discloses a power storage system provided with a storage battery array including a lead storage battery cell in which equalizing charge is implemented, and discloses supply of power to the power storage system from a commercial power source or a power supply section as a combination of power generation equipment which generates power based on renewable energy such as solar power generation, and a commercial power source.

### CITATION LIST

### Patent Literature

Patent Literature 1: WO 2019/188889

### SUMMARY OF INVENTION

### Technical Problem

The amount of power derived from renewable energy varies depending on a season, a climate, and/or the like. Therefore, in a case in which a storage battery is charged with power derived from renewable energy, the charge is frequently performed in a season or period in which the amount of power generation is large, and on the contrary, the charge is less frequently performed or is almost not performed in a season in which the amount of power generation is small. In particular, in the case of a period in which the charge is less made with the power derived from renewable energy, the state of charge of a storage battery is desired to be kept within a range suitable for preservation in order to maintain the lifetime of such a storage battery in a stable state.

In particular, a lead storage battery is required to be fully charged at a constant cycle by equalizing charge. Therefore, in a case in which equalizing charge of a storage battery is performed, such equalizing charge is required to be performed with the power supplied from an external power source in a period in which the amount of power derived from renewable energy is small. As a result, a required amount of power from an external power source necessary for equalizing charge of a power storage system is increased and the equalizing charge cost is increased in a period in which the amount of power derived from renewable energy is small. Accordingly, a system is desired in which the state of charge of a storage battery can be adjusted depending on the amount of power derived from renewable energy.

The disclosure has been made in view of the above, and an object thereof is to provide a renewable energy power generation system and a method of charging a power storage device, in which the state of charge of a storage battery can be adjusted depending on the amount of power derived from renewable energy.

### Solution to Problem

Specific solutions for solving the above problems are as follows.
<1> A renewable energy power generation system including:
   a renewable energy power generation device that generates power with renewable natural energy;
   a power storage device capable of storing power output from the renewable energy power generation device and power supplied from an external system, and capable of releasing the power stored; and
   a control section that controls charge of the power storage device so that a state of charge (SOC) of the power storage device is equal to or more than a lower limit value of a state of charge (SOC) of the power storage device, which is determined based on power generation output-related information of the renewable energy power generation device.
<2> The renewable energy power generation system according to <1>, wherein the control section controls charge of the power storage device so that the state of charge of the power storage device is equal to or more than a value obtained by subtracting a value (%) calculated with an amount of charge expected (kWh) in a certain time period, from an upper limit value (%) of the state of charge of the power storage device, and further adding a margin (%).

The power storage device in <2> may include a lead storage battery, and the renewable energy power generation system according to <2> may also be a renewable energy power generation system that controls charge of a lead storage battery.
<3> The renewable energy power generation system according to <1>, wherein the control section controls charge of the power storage device so that the state of charge of the power storage device is equal to or more than a value obtained by adding a value (%) calculated with an amount of self-discharge (kWh) in a certain time period, of the power storage device, to an original lower limit SOC value (%) of the power storage device, and further adding a margin (%).

The power storage device in <3> may include a lithium-ion secondary battery, and the renewable energy power generation system according to <3> may be a renewable energy power generation system that controls charge of a lithium-ion secondary battery.
<4> The renewable energy power generation system according to any one of <1> to <3>, wherein
   the power storage device includes a plurality of lead storage batteries, and
   the control section performs control in which power output from the renewable energy power generation device is used to charge the plurality of lead storage batteries periodically and, in a case in which equalizing charge of the plurality of lead storage batteries is not completed after a certain time period has lapsed, power is supplied from an external system to the plurality of lead storage batteries to complete the equalizing charge.
<5> A method of charging a power storage device, including using a renewable energy power generation device that generates power with renewable natural energy, and a power storage device capable of storing power output from the renewable energy power generation device and power supplied from an external system, and capable of releasing the power stored,
   to control charge of the power storage device so that a state of charge (SOC) of the power storage device is equal to or more than a lower limit value of a state of charge (SOC) of the power storage device, which is determined based on power generation output-related information of the renewable energy power generation device.
<6> The method of charging a power storage device according to <5>, wherein the power generation output-related information includes at least one of weather forecast information, or past power generation output information by the renewable energy power generation device.

### Advantageous Effect of Invention

The disclosure can provide a renewable energy power generation system and a method of charging a power storage device, in which the state of charge of a storage battery can be adjusted depending on the amount of power derived from renewable energy.

### BRIEF DESCRIPTION OF DRAWING

FIG. 1 is a diagram illustrating a configuration of one embodiment of the renewable energy power generation system of the disclosure.

### DESCRIPTION OF EMBODIMENTS

Hereinafter, modes for carrying out the present invention are described in detail. However, the invention is not limited to the following embodiments. In the following embodiments, any component (also including element step or the like) is not essential, unless particularly clearly specified. The same also applies to any numerical value and range thereof, and such any numerical value and range thereof are not intended to limit the invention. Various variations and modifications can be made by those skilled in the art without departing from technical ideas of the disclosure.

The term “step” in the disclosure encompasses not only an independent step from other steps, but also a step that can achieve a predetermined object even in the case of being not clearly distinguished from other steps.

A numerical value range represented by “(from) . . . to . . . ” in the disclosure includes numerical values described before and after “to” as a lower limit and an upper limit, respectively.

An upper limit value or a lower limit value described by a certain numerical value range in the form of a numerical value range described stepwise in the disclosure may be replaced with an upper limit value or a lower limit value of other numerical value range described stepwise. An upper limit value or a lower limit value described by a certain numerical value range in the form of a numerical value range described in the disclosure may be replaced with a value indicated in Examples.

### [Renewable Energy Power Generation System]

The renewable energy power generation system of the disclosure is a system including a renewable energy power generation device that generates power with renewable natural energy, a power storage device capable of storing power output from the renewable energy power generation device and power supplied from an external system, and capable of releasing the power stored, and a control section that controls charge of the power storage device so that a state of charge (SOC) of the power storage device is equal to or more than the lower limit value of a state of charge (SOC) of the power storage device, which is determined based on power generation output-related information of the renewable energy power generation device.

The renewable energy power generation system of the disclosure is a system that controls charge (preferably charge/discharge) of the power storage device based on information on power generation output of the renewable energy power generation device (power generation output-related information). Therefore, for example, the lower limit value of SOC in a period in which the amount of power generation in the renewable energy power generation device is small is set to be higher than that in a period in which the amount of power generation in the renewable energy power generation device is large, and the range of SOC is adjusted. Thus, for example, the amount of power from the external, necessary for equalizing charge of the power storage device, and the amount of power from the external, necessary for a state of charge capable of suppressing over discharge, battery degradation, or the like can be reduced. As a result, the electricity price can be saved in a period in which the amount of power generation in the renewable energy power generation device is small. For example, SOC can be increased by decreasing the amount of discharge of the power storage device in a period in which the amount of power generation in the renewable energy power generation device is small.

The renewable energy power generation system of the disclosure is a power generation system that can be utilized in, for example, a dwelling facility such as a housing complex or a single-family house, a plant facility, a farm facility, a commercial facility, a data center, a substation, a public facility, a cultural facility, a sporting facility, or any complex facility thereof.

The renewable energy power generation device included in the renewable energy power generation system of the disclosure is not particularly limited as long as the device is a power generation device that generates power with renewable natural energy. Examples of the renewable natural energy include solar light, wind power, biomass, water power, geothermal heat, solar heat, tidal current, or tidal power.

In particular, the renewable natural energy is preferably solar light or wind power, and the renewable energy power generation device is preferably a power generation device with solar light, a power generation device with wind power, or any combination thereof. Examples of the power storage device include a secondary battery in which

charge/discharge can be repeated. Specific examples of the power storage device include a lead storage battery, a lithium-ion secondary battery, a nickel-cadmium battery, a nickel-hydrogen battery, a nickel-zinc battery, or a sodium-sulfur battery. The power storage device may be used singly, or in combination of two or more kinds thereof.

The power storage device may include at least one of a lead storage battery or a lithium-ion secondary battery. The power storage device may be a device including only one of a lead storage battery or a lithium-ion secondary battery, or may be a combination of a lead storage battery and a lithium-ion secondary battery.

The power storage device may include a storage battery string in which a plurality of storage battery cells is connected in series, or may have a configuration in which one storage battery cell or storage battery string is connected in parallel.

The control section is a device that controls charge of the power storage device so that the state of charge (SOC) of the power storage device is equal to or more than the lower limit value of the SOC of the power storage device, which is determined based on power generation output-related information of the renewable energy power generation device. For example, the control section controls charge of the power storage device so that the SOC is in a range equal to or more than the lower limit value of the SOC. The control section may be configured by including, for example, a BMU (Battery Management Unit) that monitors the state of the power storage device, and a general controller that controls charge/discharge of the power storage device and also acquires power generation output-related information of the renewable energy power generation device via the Internet from a system external. The BMU is a device that monitors the state of the power storage device by sequentially acquiring the voltage value and the current value of a storage battery cell or storage battery string, measured with a voltmeter and an ammeter, and determining the state of charge (SOC) from at least one (for example, current value) of the voltage value or the current value acquired.

The control section may control charge of the power storage device so that the lower limit value of the SOC is determined based on power generation output-related information of the renewable energy power generation device and the SOC is equal to or more than the lower limit value of the determined SOC of the power storage device. Alternatively, the lower limit value of the SOC may be predetermined based on power generation output-related information of the renewable energy power generation device, and the control section may control charge of the power storage device so that the SOC is equal to or more than the lower limit value of the predetermined SOC of the power storage device.

Such power generation output-related information is not particularly limited as long as such information is information relating to the power output in a certain time period in the renewable energy power generation device, and examples thereof include weather forecast information, or past power generation output information by the renewable energy power generation device. Examples of such weather forecast information include weather forecast information at the closest site to the site at which the renewable energy power generation device is disposed, or weather forecast information at a plurality of sites adjacent to the site at which the renewable energy power generation device is disposed. Examples of such weather forecast information include information on an ambient temperature, weather, a wind speed, a humidity, any combined information thereof, or any other information relating to power generation output of the renewable energy power generation device. The amount of power output in the renewable energy power generation device over a current certain time period or a future certain time period may be presumed from past power generation output information by the renewable energy power generation device.

The lower limit value of the SOC may be determined based on not only power generation output-related information of the renewable energy power generation device, but also charge/discharge information of the power storage device, degradation information of the power storage device, or the like. Examples of such charge/discharge information of the power storage device and degradation information of the power storage device include information on the number of charge/discharge times, the duration of use, the usage environment, the capacity reduction, or the like of the power storage device. The lower limit value of the SOC may be determined in consideration of such charge/discharge information of the power storage device, degradation information of the power storage device, or the like.

The renewable energy power generation system of the disclosure may be electrically connected to a load, and may include a power conditioning system (PCS) that converts direct-current power to alternating-current power having a predetermined frequency, or converts alternating-current power to alternating-current power having another predetermined frequency.

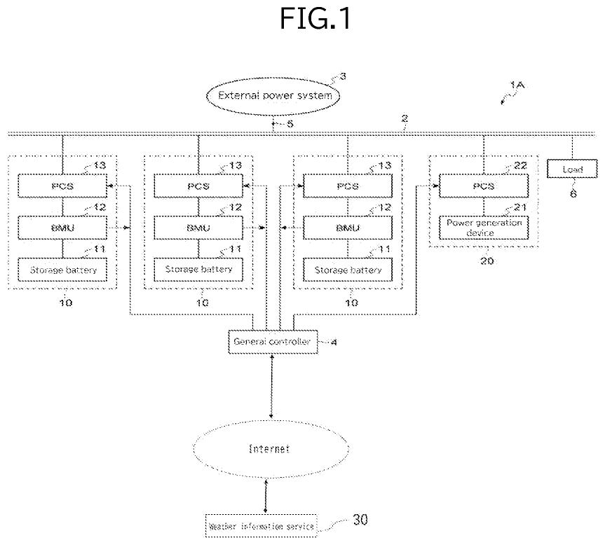

Hereinafter, the power storage system of the disclosure is described with one embodiment of the renewable energy power generation system of the disclosure, with reference to FIG. 1. FIG. 1 is a diagram illustrating a configuration of one embodiment of the renewable energy power generation system of the disclosure.

A renewable energy power generation system 1A includes an internal power wire 2, a plurality of power storage units 10, one, or a plurality of power generation units 20, and a general controller 4.

The internal power wire 2 propagates alternating-current power having a predetermined frequency (for example, a commercial frequency of 50 Hz or 60 Hz). The internal power wire 2 is a wire laid in a local region such as a house, a plant, or a farm, in a limited manner, and is electrically connected to a load 6. The renewable energy power generation system 1A can supply the power generated by the power generation unit 20, and the power discharged from the power storage units 10, to the load 6 via the internal power wire 2. The load refers to one or more instruments or devices in which power is consumed, or any aggregation thereof. The internal power wire 2 is electrically connected via a linkage point 5 to an external power system 3 disposed outside of the local area.

The power generation unit 20 is electrically connected to the internal power wire 2, to generate power with renewable natural energy. The power generation unit 20 has a renewable energy power generation device 21 and a power conditioning system (PCS) 22. The renewable energy power generation system 1A may include a plurality of the power generation units 20. The renewable energy power generation device 21 is electrically connected via the PCS 22 to the internal power wire 2, and generates power with renewable natural energy. The renewable energy power generation device 21 is, for example, solar panel or wind power generation equipment. The PCS 22 is configured by including an inverter. In a case in which the renewable energy power generation device 21 generates direct-current power, the PCS 22 converts this direct-current power to alternating-current power having a predetermined frequency, and supplies the alternating-current power to the internal power wire 2. In a case in which the renewable energy power generation device 21 generates alternating-current power, the PCS 22 converts the frequency of this alternating-current power to a predetermined frequency, and supplies the alternating-current power to the internal power wire 2. The PCS 22 may be integrated with PCS 13 described below.

Each of the power storage units 10 has a storage battery 11, a battery management unit (BMU) 12, and PCS 13. The storage battery 11 stores the power generated by the power generation unit 20. The storage battery 11 may include a single storage battery cell, or may be configured from a plurality of storage batteries mutually connected in series. The BMU 12 is electrically connected between the storage battery 11 and the PCS 13. The BMU 12 may manage the equalizing charge interval in the storage battery 11. Furthermore, the BMU 12 determines the state of charge (SOC) of the storage battery 11 from the integrated value of the current input to or output from the storage battery 11, and the voltage between both ends of the storage battery 11. The PCS 13 is electrically connected between the storage battery 11 and the internal power wire 2. The PCS 13 performs charge/discharge of the storage battery 11 based on the instruction from the general controller 4. The PCS 13 is configured by including an inverter. The PCS 13 also performs conversion of direct-current power to alternating-current power having a predetermined frequency, during release of the power of the storage battery 11 to the internal power wire 2. The PCS 13 also performs conversion of alternating-current power to direct-current power, during storage of the power of the internal power wire 2 in the storage battery 11. While the BMU 12 and the PCS 13 are provided with respect to each of such storage batteries 11 in FIG. 1, one BMU or one PCS may be electrically connected to a plurality of such storage batteries 11.

The general controller 4 controls an operation (charge operation and discharge operation) of the PCS 13 in each of the power storage units 10, and acquires power generation output-related information such as weather forecast information from a weather information service 30 via the Internet. Furthermore, the general controller 4 outputs a control signal, and the PCS 13 receiving the control signal controls charge/discharge of the storage battery 11 so that the SOC of the storage battery 11 is equal to or more than the lower limit value of the SOC determined based on power generation output-related information such as weather forecast information or past power generation output information by the renewable energy power generation device, charge/discharge information of the power storage device, degradation information of the power storage device, and/or the like.

The general controller 4 allows the PCS 13 in each of the power storage units 10 to perform a discharge operation in a case in which the consumed power of the load 6 is above the power generated in the power generation unit 20. The general controller 4 here controls the discharge operation so that the SOC of the storage battery 11 is not less than the specified lower limit value in each of the power storage units 10. Specifically, power supply is controlled by supplying the shortfall of power from the external power system 3 to the load 6 to allow the SOC of the storage battery 11 to be equal to or more than the specified lower limit value.

The general controller 4 allows the PCS 13 in each of the power storage units 10 to perform a charge operation with the power generated in the power generation unit 20 in a case in which the consumed power of the load 6 is below the power generated in the power generation unit 20.

The general controller 4 and the BMU 12 can each include a computer (for example, microcomputer) including a processor, a memory, and a communication interface. While the processor includes, for example, a CPU and the memory includes, for example, a flash memory, the type of each hardware device included in the general controller 4 and the BMU 12 is not limited thereto, and may be arbitrarily selected. Each function of the general controller 4 and the BMU 12 is realized by executing a program stored in the memory by the processor. For example, the processor executes predetermined computation of the data read out from the memory or the data received via the communication interface, and outputs the computation result. Alternatively, the processor stores the data received or the computation result in the memory. For example, the processor in the general controller 4 preferably performs control of charge of the storage battery 11 so that the SOC of the storage battery 11 is equal to or more than the lower limit value of the SOC of the storage battery 11 determined based on power generation output-related information.

In a case in which the storage battery 11 is a lead storage battery, equalizing charge that allows a lead storage battery to be fully charged is periodically (for example, every one to two weeks) performed. For example, the general controller 4 controls a charge operation of the storage battery 11 so that charge of the storage battery 11 is performed over a certain time (for example, several hours) with the power generated in the power generation unit 20. The general controller 4 performs control including supplying the shortfall of power from the external power system 3 to the storage battery 11 to complete equalizing charge in the case in which the equalizing charge of the storage battery 11 is not completed after a certain time period has lapsed (for example, after one to two weeks from the previous equalizing charge has lapsed). As an example, the general controller 4 may perform control including performing equalizing charge every 14 days and performing charge of the storage battery 11 with the power generated in the power generation unit 20 over 10 hours, and may perform control including supplying the shortfall of power from the external power system 3 to the storage battery 11 to complete equalizing charge in the case in which the equalizing charge of the storage battery 11 is not completed after 14 days from the previous equalizing charge has lapsed.

The general controller 4 preferably controls charge of the storage battery 11 so that the state of charge of the storage battery 11 is equal to or more than the value obtained by subtracting the value (%) calculated with the amount of charge expected (kWh) in a certain time period, from the upper limit value (%) of the state of charge of the storage battery 11, and furthermore adding a margin (%). Thus, the state of charge of the storage battery 11 is controlled within a range considering the amount of charge expected (kWh) in a certain time period. The storage battery 11 may be here a lead storage battery.

More specifically, the general controller 4 may control charge of the storage battery 11 so that the following Formula (1) is satisfied.

$$Lower limit SOC value \geq Upper limit SOC value - [ Q / battery capacity ] \times 100 + α \qquad Formula ( 1 )$$

In Formula (1), the lower limit SOC value (%) is the lower limit value of the state of charge of the storage battery 11, the upper limit SOC value (%) is the upper limit value of the state of charge of the storage battery 11, Q (kWh) is the amount of charge expected in a certain time period, the battery capacity (kWh) is the battery capacity of the storage battery 11, and a (%) is a margin.

The upper limit SOC value (%) may be a SOC in the case of the storage battery 11 that is in a fully charged state, and a (%) may be, if appropriate, adjusted by the usage state, the usage environment, and/or the like of the storage battery, the renewable energy power generation system, and/or the like. The amount of charge expected in a certain time period may be the amount of charge expected in a certain time period of the next day, the next week, the next month, or the like, or may be the average amount of charge expected in a future certain time period (for example, the amount of charge expected on one-day average, one-week average, or one-month average). The amount of charge expected may be the amount of power, obtained by subtracting the predicted power of supply (kWh) to the load and the predicted power of supply (kWh) to the system external (for example, the sold power (kWh)), from the amount of power generation expected (kWh). A period in which the amount of power generation in the renewable energy power generation device 21 (for example, a summer season in which the amount of solar power generation is large) tends to be larger in the amount of charge expected, and a period in which the amount of power generation in the renewable energy power generation device 21 is small (for example, a winter season in which the amount of solar power generation is small) tends to be smaller in the amount of charge expected. As a result, a period in which the amount of power generation in the renewable energy power generation device 21 is large is relatively lower in the lower limit SOC value, and a period in which the amount of power generation in the renewable energy power generation device 21 is small is relatively higher in the lower limit SOC value.

Also in a period in which the amount of power generation in the renewable energy power generation device 21 is small, for example, a winter season in which the amount of solar power generation is small or a summer season in which the amount of wind power generation is small, the SOC of the storage battery 11 is controlled so that the SOC of the storage battery 11 is not less than the specified lower limit value, for example, the SOC of the storage battery 11 is controlled so that the SOC of the storage battery 11 is kept around the specified lower limit value (is here equal to or more than the specified lower limit value). Therefore, also in a period in which the amount of power generation in the renewable energy power generation device 21 is small, the amount of external power needed for equalizing charge can be saved, and the electricity cost needed for equalizing charge can be saved.

In a case in which general controller 4 controls the SOC of the storage battery 11 so that the above Formula (1) is satisfied, charge/discharge of the storage battery 11 is controlled within a range satisfying Formula (1), and the shortfall of power, corresponding to the power consumed by the load 6 during the control of the SOC of the storage battery 11, is supplied from the external power system 3 to the load 6.

The general controller 4 preferably controls charge of the storage battery 11 so that the state of charge of the storage battery 11 is equal to or more than the value obtained by adding the value (%) calculated with the amount of self-discharge (kWh) in a certain time period, of the storage battery 11, to the original lower limit SOC value (%) of the storage battery 11, and furthermore adding a margin (%). Thus, the state of charge of the storage battery 11 is controlled within a range considering the amount of self-discharge (kWh) in a certain time period, and, for example, the risk of over discharge can be reduced. The storage battery 11 may be here a lithium-ion secondary battery.

More specifically, the general controller 4 may control charge of the storage battery 11 so that the following Formula (2) is satisfied.

$$Lower limit SOC value \geq Original lower limit SOC value of storage battery 11 + [ Qs / battery capacity ( kWh ) ] \times 100 \times x + β \qquad Formula ( 2 )$$

In Formula (2), the lower limit SOC value (%) is the lower limit value of the state of charge of the storage battery 11, the original lower limit SOC value (%) of the storage battery 11 is the lower limit value of a possible state of charge of the storage battery 11, Qs (kWh) is the amount of self-discharge for one month in the storage battery 11, the battery capacity (kWh) is the battery capacity of the storage battery, x (months) is a time period in which the amount of power generation in the renewable energy power generation device 21 is presumed to satisfy a specified condition, and β(%) is a margin.

In a case in which the general controller 4 operates with the power of the storage battery 11, the SOC of the storage battery 11 is preferably controlled by including the consumed power of the general controller 4 in the amount of self-discharge.

The original lower limit SOC value (%) of the storage battery 11 may be a lower limit SOC value that can be achieved by the storage battery 11 in terms of function, or may be a SOC value corresponding to the remaining amount of power storage usually kept in preparation for a power outage or the like.

The risk of over discharge can be suitably reduced by controlling the SOC of the storage battery 11 so that Formula (2) is satisfied.

β(%) may be, if appropriate, adjusted by the usage state, the usage environment, and/or the like of the storage battery, the renewable energy power generation system, and/or the like. The time period in which a specified condition in x (months) is presumed to be satisfied may be a time period in which the amount of power generation in the renewable energy power generation device 21 is presumed to be equal to or less than a certain amount of power generation, or may be a time period in which the amount of power generation per month, in the renewable energy power generation device 21, is presumed to be equal to or less than a specified proportion with respect to the maximum amount of power generation per month.

x (months) may be a time period in which a specific condition within 12 months from the relevant time is presumed to be satisfied, or may be a time period in which a specific condition within 6 months from the relevant time is presumed to be satisfied.

The renewable energy power generation system 1A may include a lead storage battery and a lithium-ion secondary battery each serving as the storage battery 11. For example, the renewable energy power generation system 1A may include a power storage unit 10 (designated as “power storage unit 10A”) including a lead storage battery, as the storage battery 11, and a power storage unit 10 (designated as “power storage unit 10B”) including a lithium-ion secondary battery, as the storage battery 11, in parallel. In such a case of the storage battery 11 (lead storage battery) included in the power storage unit 10A, charge of the storage battery 11 may be controlled so that the state of charge of the storage battery 11 is equal to or more than the value obtained by subtracting the value (%) calculated with the amount of charge expected (kWh) in a certain time period, from the upper limit value (%) of the state of charge of the storage battery 11, and furthermore adding a margin (%), and charge of the storage battery 11 may be preferably controlled so that Formula (1) is satisfied. In the case of the storage battery 11 (lithium-ion secondary battery) included in the power storage unit 10B, charge of the storage battery 11 may be controlled so that the state of charge of the storage battery 11 is equal to or more than the value obtained by adding the value (%) calculated with the amount of self-discharge (kWh) in a certain time period, of the storage battery 11, to the original lower limit SOC value (%) of the storage battery 11, and furthermore adding a margin (%), and charge of the storage battery 11 may be preferably controlled so that Formula (2) is satisfied.

The method of charging a power storage device of the disclosure is a method including using a renewable energy power generation device that generates power with renewable natural energy, and a power storage device capable of storing power output from the renewable energy power generation device and power supplied from a system external, and capable of releasing the power stored, to control charge of the power storage device so that a state of charge (SOC) of the power storage device is equal to or more than the lower limit value of a state of charge (SOC) of the power storage device, which is determined based on power generation output-related information of the renewable energy power generation device. The method of charging a power storage device can be realized with the renewable energy power generation system of the disclosure.

### (Saving of Electricity Cost by Equalizing Charge)

Hereinafter, the effect of saving of the electricity cost in equalizing charge performed by the method of charging a power storage device of the disclosure in the case of the storage battery being a lead storage battery is described.

The number of times of equalizing charge per month is defined as y (times/month), the original lower limit SOC of the lead storage battery is defined as SOC_Llimit (%), the lower limit SOC in the case of the control of the disclosure being performed is defined as SOC_LClimit (%), the battery capacity of the lead storage battery is defined as Q (kWh), and the electricity cost is defined as z (¥/kWh). The original lower limit SOC of the lead storage battery refers to a SOC in the case of control of the lower limit SOC being not performed. The effect of saving of the electricity cost for one month by equalizing charge is represented by the following Formula (3).

$$( SOC\_LClimit - SOC\_Llimit ) \times Q \times z \times y \qquad Formula ( 3 )$$

### Comparative Example 1

A case in which control of the lower limit SOC is not performed is adopted as Comparative Example 1. The number y of times of equalizing charge per month is set to twice/month (24 times/year on year conversion), the battery capacity Q of the lead storage battery is set to 40 kWh, and the electricity cost z is set to 20 ¥/kWh. In a case in which the original lower limit SOC of the lead storage battery is assumed to be 30% and all the shortfall of power for equalizing charge is assumed to be acquired from an external power system, the electricity cost for equalizing charge in Comparative Example 1 is calculated as follows.

$$[ ( 100 - 30 ) / 100 ] \times 40 \times 20 \times 24 = ¥ 13440$$

### Example 1

A case in which control of the lower limit SOC is performed is adopted as Example 1. It is assumed in Example 1 that the lower limit SOC in January through March and the lower limit SOC in October through December are each controlled to be 80% and the lower limit SOC in April through June and the lower limit SOC in July through September are each controlled to be 30% as a result of control of the lower limit SOC based on Formula (1). Furthermore, in a case in which all the shortfall of power for equalizing charge is assumed to be acquired from an external power system, the electricity cost for equalizing charge in Example 1 is calculated as follows.

$$[ ( 100 - 80 ) / 100 ] \times 40 \times 20 \times 12 + [ ( 100 - 30 ) / 100 ] \times 40 \times 20 \times 12 = ¥ 8640$$

### Example 2

A case in which control of the lower limit SOC is performed in a different way from Example 1 is adopted as Example 2. It is assumed in Example 2 that the lower limit SOC is controlled to be 100% in January through March and October through December in which the amount of charge expected per month is decreased. Furthermore, in a case in which all the shortfall of power for equalizing charge is assumed to be acquired from an external power system, the electricity cost for equalizing charge in Example 2 is calculated as follows.

$$[ ( 100 - 100 ) / 100 ] \times 40 \times 20 \times 12 + [ ( 100 - 30 ) / 100 ] \times 40 \times 20 \times 12 = ¥ 6720$$

The results in Examples 1, 2, and Comparative Example 1 are summarized as shown in the following Table 1. As shown in Table 1, the effect of saving of the electricity cost is obtained in each of Examples 1 and 2, as compared with Comparative Example 1.

TABLE 1

| | | Example | Example | Comparative |
|---|---|---|---|---|
| | | 1 | 2 | Example 1 |
| Lower | January through March | 80 | 100 | 30 |
| limit | April through June | 30 | 30 | 30 |
| SOC | July through September | 30 | 30 | 30 |
| (%) | October through | 80 | 100 | 30 |
| | December | | | |

| | | | |
|---|---|---|---|
| Number of times of equalizing | 24 | 24 | 24 |
| charge (times/year) | | | |
| Electricity cost (¥) needed | 8,640 | 6,720 | 13,440 |
| for equalizing charge | | | |
| Effect of saving with respect | 4,800 | 6,720 | — |
| to “Comparative Example 1” (¥) | | | |

The disclosure of Japanese Patent Application No. 2022-091548 filed on Jun. 6, 2022 is herein incorporated by reference in its entirety.

All documents, patent applications, and technical standards described herein are herein incorporated by reference, as if each individual document, patent application, and technical standard were specifically and individually indicated to be incorporated by reference.

### REFERENCE SIGNS LIST

1A . . . Power storage system
2 . . . Internal power wire
3 . . . External power system
4 . . . General controller
5 . . . Linkage point
6 . . . Load
10 . . . Power storage unit
11 . . . Storage battery
12 . . . Battery management unit (BMU)
13, 22 . . . Power conditioning system (PCS)
20 . . . Power generation unit
21 . . . Power generation device
30 . . . Weather information service

1. A renewable energy power generation system, comprising:
a renewable energy power generation device that generates power with renewable natural energy;
a power storage device capable of storing power output from the renewable energy power generation device and power supplied from an external system, and capable of releasing the power stored; and
a control section that controls charge of the power storage device so that a state of charge (SOC) of the power storage device is equal to or more than a lower limit value of a state of charge (SOC) of the power storage device, which is determined based on power generation output-related information of the renewable energy power generation device.

2. The renewable energy power generation system according to claim 1, wherein the control section controls charge of the power storage device so that the state of charge of the power storage device is equal to or more than a value obtained by subtracting a value (%) calculated with an amount of charge expected (kWh) in a certain time period, from an upper limit value (%) of the state of charge of the power storage device, and further adding a margin (%).

3. The renewable energy power generation system according to claim 1, wherein the control section controls charge of the power storage device so that the state of charge of the power storage device is equal to or more than a value obtained by adding a value (%) calculated with an amount of self-discharge (kWh) in a certain time period, of the power storage device, to an original lower limit SOC value (%) of the power storage device, and further adding a margin (%).

4. The renewable energy power generation system according to claim 1, wherein:
the power storage device comprises a plurality of lead storage batteries, and
the control section performs control in which power output from the renewable energy power generation device is used to charge the plurality of lead storage batteries periodically and, in a case in which equalizing charge of the plurality of lead storage batteries is not completed after a certain time period has lapsed, power is supplied from an external system to the plurality of lead storage batteries to complete the equalizing charge.

5. A method of charging a power storage device, comprising using a renewable energy power generation device that generates power with renewable natural energy, and a power storage device capable of storing power output from the renewable energy power generation device and power supplied from an external system, and capable of releasing the power stored,
to control charge of the power storage device so that a state of charge (SOC) of the power storage device is equal to or more than a lower limit value of a state of charge (SOC) of the power storage device, which is determined based on power generation output-related information of the renewable energy power generation device.

6. The method of charging a power storage device according to claim 5, wherein the power generation output-related information comprises at least one of weather forecast information, or past power generation output information by the renewable energy power generation device.
